(19) United States
(12) Patent Application Publication
(10) Pub. No.: US 2024/0070551 A1
(43) Pub. Date: Feb. 29, 2024

(54) MACHINE LEARNING MODEL TRAINING SYSTEM AND METHOD

(71) Applicants: Inventec (Pudong) Technology Corporation, Shanghai (CN); INVENTEC CORPORATION, TAIPEI CITY (TW)

(72) Inventors: Trista Pei-Chun CHEN, TAIPEI CITY (TW); Po Hsuan HUANG, TAIPEI CITY (TW)

(21) Appl. No.: 17/932,278

(22) Filed: Sep. 14, 2022

(30) Foreign Application Priority Data
Aug. 29, 2022 (CN) 202211042439.1

(51) Int. Cl. G06N 20/20

(52) U.S. Cl. CPC G06N 20/20

(57) ABSTRACT

A machine learning model training method, for training a machine learning model, includes following steps. A first model is trained according to a first set of labels and a first training set. A third training set which is a portion of the training data not included in the first training set is labeled according to the first model, so as to generate a third set of labels. A second model is pre-trained according to the third set of labels and the third training set. The second model is fine-tuned according to the second set of labels and the second training set, so as to generate a third model.

### CROSS-REFERENCE TO RELATED APPLICATION

This application claims priority to China Application Serial Number 202211042439.1, filed Aug. 29, 2022, which is herein incorporated by reference in its entirety.

### BACKGROUND

### Field of Invention

The present invention relates to a machine learning model training system, method, and non-transitory computer-readable storage medium. More particularly, the present invention relates to a data labeling machine learning model training system, method, and non-transitory computer-readable storage medium.

### Description of Related Art

Data labeling machine learning model has been applied in many technical field nowadays, e.g., medical image interpretation and product yield rate monitoring. In order to perform data labeling, a machine learning model training system and corresponding method are utilized to train a model according to manual-labeled training data, which may contain data labeled in different categories by different data labelers. Therefore, there is a need to utilize such training data to train a machine learning model and prevent the trained machine learning model from being deviated.

### SUMMARY

The disclosure provides a machine learning model training method, which includes following steps. A first model is trained according to a first set of labels and a first training set. A third training set, which is a portion of the training data not included in the first training set, is labeled according to the first model, so as to generate a third set of labels. A second model is pre-trained according to the third set of labels and the third training set. The second model is fine-tuned according to the second set of labels and the second training set, so as to generate a third model.

The disclosure provides a machine learning model training method, which includes following steps. A first model is trained according to a first set of labels and a first training set. A third training set, which is a portion of the training data not included in the first training set, is labeled according to the first model, so as to generate a third set of labels. A second model is pre-trained according to the second set of labels and the second training set. The second model is fine-tuned according to the third set of labels and the third training set, so as to generate a third model.

The disclosure provides a machine learning model training system, which includes a storing device and a processor. The storing device is configured to store training data, a first set of labels, and a second set of labels. The training data is configured to train a machine learning model. The first set of labels corresponds to a first training set of the training data. The second set of labels corresponds to a second training set of the training data. The processor is electrically connected to the storing device. The processor is configured to train a first model according to the first set of labels and the first training set. The processor is further configured to label a third training set, which is a portion of the training data not included in the first training set, according to the first model, so as to generate a third set of labels. The processor is further configured to pre-train a second model according to the third set of labels and the third training set, or according to the second set of labels and the second training set. The processor is further configured to fine-tune the second model according to the second set of labels and the second training set, or according to the third set of labels and the third training set, so as to generate a third model.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a machine learning model training system according to some embodiments of this disclosure.

FIG. 2A is a schematic diagram illustrating a training data according to some embodiments of this disclosure.

FIG. 2B is a schematic diagram illustrating a structure of a machine learning model according to some embodiments of this disclosure.

FIG. 3 is a flow diagram illustrating a machine learning model training method according to some embodiments of this disclosure.

FIG. 4 is a flow diagram illustrating another machine learning model training method according to some embodiments of this disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

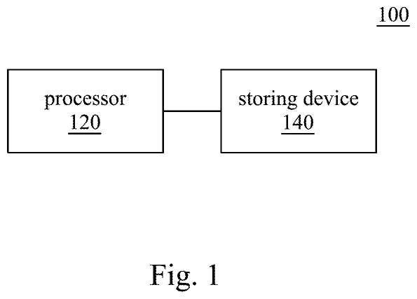

Reference is made to FIG. 1, which is schematic diagram illustrating a machine learning model training system 100 according to some embodiments of this disclosure. The machine learning model training system 100 includes a processor 120 and a storing device 140. The processor 120 and the storing device 140 are electrically connected. The machine learning model training system 100 is configured to generate a machine learning model. In some embodiments, the machine learning model is applied to image labeling, image classification, or data augmentation. For example, through calculations through the machine learning model, product images are classified into product images of defected products and product images of well-made products, or medical images are classified into medical images with abnormal physiological features and medical images without abnormal physiological features.

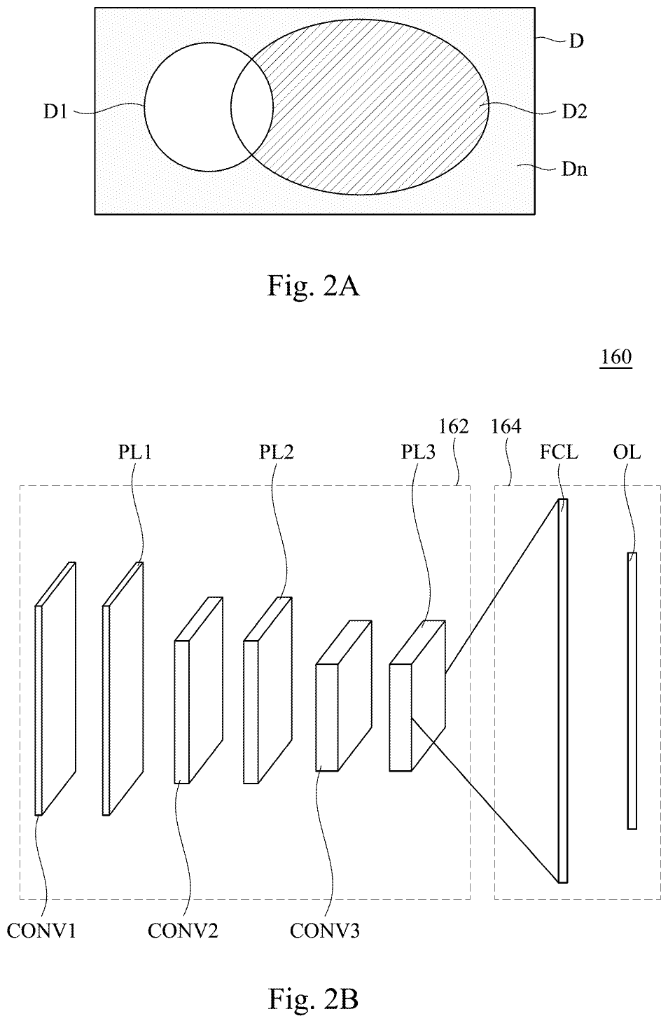

Reference is made to FIG. 2A, which is a schematic diagram illustrating a training data D according to some embodiments of this disclosure. The storing device 140 is configured to store the training data D, a first set of labels L1, and a second set of labels L2. The training data D includes a first training set D1, a second training set D2, and other training data Dn. The first training set D1, the second training set D2, and the other training data Dn can be used to train the machine learning model separately. The first set of labels L1 (not shown in figures) corresponds to the first training set D1 of the training data D, and the second set of labels L2 (not shown in figures) corresponds to the second training set D2 of the training data D.

In some embodiments, the training data D includes product images or medical images, correspondingly, the first set of labels L1 and the second set of labels L2 are product quality labels of the product images (e.g., images of well-made product and/or images of defected product), or physiological feature labels of the medical images (e.g., images with abnormal physiological feature and/or images without abnormal physiological feature).

In some embodiments, training of a machine learning model is to input the product quality labels (label as well-made products and/or defected products) and the corresponding product images to the machine learning model separately, and to classify the product images by determining the products in the product images are defected or not by the machine learning model. After the machine learning model generates classification results, checking the classification results with the product quality labels in order to provide a corresponding reward signals or punish signals. For example, providing the reward signal in response to one of the classification results match the corresponding product quality label, and providing the punish signal in response to one of the classification result does not match the corresponding product quality label, and then finish the training of the machine learning model.

Reference is also made to FIG. 2B, which is a schematic diagram illustrating a structure of a machine learning model 160 according to some embodiments of this disclosure. In an embodiment, as shown in FIG. 2B, the machine learning model 160 includes a feature extractor 162 and a classifier 164. The feature extractor 162 may include convolution layers CONV1-CONV3 and pooling layers PL1-PL3. The convolution layers CONV1-CONV3 are configured to perform convolution calculation base on eigenvectors of input images. The pooling layers PL1-PL3 are configured to simplified representation of the eigenvectors. The classifier 164 includes a fully connected layer FCL and an output layer OL. The classifier 164 is configured to generate an output label, i.e., a classification result, based on the eigenvectors calculated by the feature extractor 162. In some embodiments, the machine learning model 160 is based on VGG-16 algorithm.

In some embodiments, the first training set D1 is a portion of the training data D labeled by a first labeler, and the second training set D2 is a portion of the training data D labeled by a second labeler, wherein the first labeler is a labeler which has a higher correct rate than the second labeler. The other training data Dn is a portion of the training data D which is neither labeled by the first labeler nor labeled by the second labeler, nor labeled by the first labeler and/or the second labeler, but fail to be labeled due to unrecognizable or other reason. More particularly, in some embodiments, given the training data D includes the product images, the first labeler can include label sources which are relatively more experienced and/or having relatively higher correct rates with the product images, such as product supervisors, and senior production line staffs, and the second labeler can include label sources which are relatively less experienced and/or having relatively lower correct rates, such as junior staffs; and given the training data D includes the medical images, the first labeler can include label sources which are relatively more experienced and/or having relatively higher correct rates with the medical images, such as senior doctors, and the second labeler can include label sources which are relatively less experienced and/or having relatively lower correct rates, such as junior medical staffs. Besides, the first labeler can also include labeling means tested and/or certified for having relatively higher correct rates, such as artificial intelligence models and machine learning models verified for having certain extent of correct rates by test data; relatively, the second labeler can also include untested and/or uncertified labeling means, or labeling means with relatively lower correct rates, such as artificial intelligence models and/or machine learning models which are untested, or verified for having relatively lower correct rates by test data.

According to the embodiments above, the first set of labels L1 corresponds to the first training set D1 has a relatively higher correct rate than the second set of labels L2 corresponds to the second training set D2. As for the other training data Dn, which is training data that unlabeled and/or failed to be labeled, thus without corresponding labels.

In some embodiments, the second training set D2 is a portion which is labeled with same labels generated by second labelers of the training data D, wherein the same labels are used as the second set of labels L2 (i.e., a circle tagged with D2, includes a portion of the first training set D1 in the FIG. 2A). Relatively, another portion, which is labeled with different labels generated by the second labelers, of the training data D is not included in the second training set D2 (i.e., a portion of the rectangle tagged with D not enclosed by the circle tagged with D2, includes a portion of the first training set D1 and the other training data Dn in the FIG. 2A). More particularly, in some embodiments, a plural-agreed training data is a portion of the training data D labeled by the second labelers, and labels generated are agreed by plural labelers, e.g., a product image is labeled as defected product by both of production line staffs, so that the label agreed by plural labelers is categorized to the second set of labels L2, and the plural-agreed training data is categorized to the second training set D2. In other hands, a plural-disagreed training data is a portion of the training data D labeled by the second labelers and plural different labels generated by plural labelers with same training data, e.g., a product image is labeled as a defected product by a production line staff, but is labeled as a well-made product by another production line staff, the plural-disagreed training data is not categorized to the second training set D2, and due to the plural-disagreed training data has been labeled with the different labels, the different labels have a relatively lower correct rate than the second set of labels L2 corresponds to the plural-agreed training data. In some embodiments, the other training data can also include training data which is unlabeled and/or failed to be labeled.

Also, the first training set D1 is a portion of the training data D labeled by a first labeler, which correspondingly generates a first set of labels L1, wherein the first labeler is a labeler which has a higher correct rate than the second labelers. It is noticed that, as shown in FIG. 2A, there may be an intersection among the first training set D1 and the second training set D2, that is, the training data D may include training data that is not only categorized to the first training set D1, but also categorized to the second training set D2 at the same time.

Thus, as mentioned in the embodiments above, the first set of labels L1, which corresponds to the first training set D1, has a relatively higher correct rate and reliability than the second set of labels L2, which corresponds to the second training set D2. Also, the second set of labels L2, which corresponds to the second training set D2, has a relatively higher correct rate and reliability than the different labels, which correspond to the plural-disagreed training data.

Generally, in order to generate a machine learning model with a high correct rate and reliability, not only a training data with a high correct rate and reliability is needed, but also a large quantity of the training data is necessary, otherwise the machine learning model may be overfitted. However, as mentioned in the embodiments above, the other training data Dn cannot be used for machine learning model training due to not having corresponding labels or the corresponding labels having relatively lower reliability. Besides, the first training set D1 has a different correct rate and reliability from the second training set D2. It is not suitable for the first training set D1 and the second training set D2 to train a machine learning model using same method. Also, despite the first training set D1 has a relatively higher correct rate, in general, training data with a higher correct rate implies smaller quantity of training data, there is a high chance leads to overfitting if training a machine learning model according to a small quantity of the first training set D1.

Therefore, a machine learning model training method 210 and a machine learning model training method 220 are provided in present disclosure. The machine learning model training method 210 and the machine learning model training method 220 are configured to transform the first training set D1, the second training set D2, and the other training data Dn into utilizable training data. The machine learning model training method 210 and the machine learning model training method 220 utilize all of the training data D, including the first training set D1, the second training set D2, and the other training data Dn, to train a machine learning model, and to generate a machine learning model with a relatively higher correct rate and reliability by utilizing the training data D better. Details about the machine learning model training method 210 and the machine learning model training method 220 will be discussed in following paragraphs.

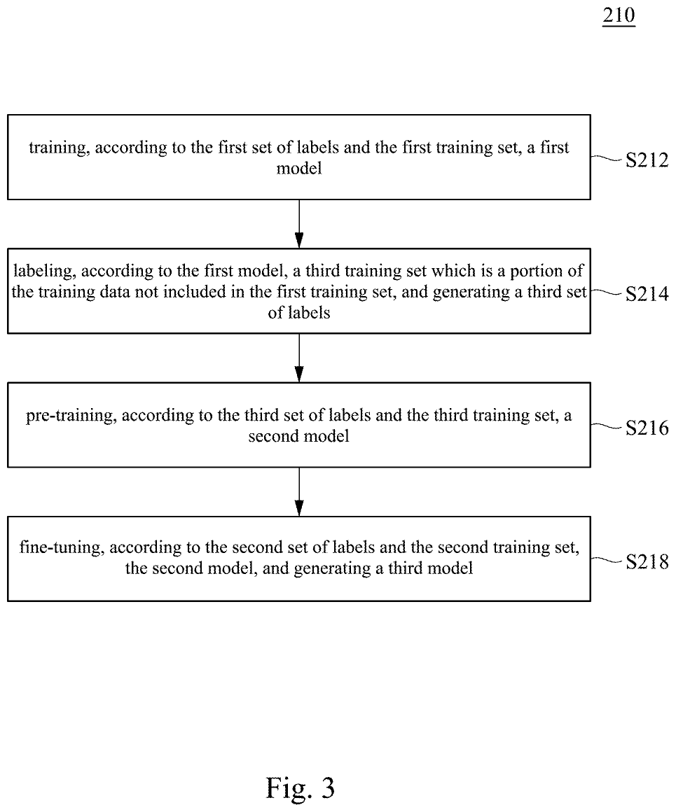

Reference is made to FIG. 3, which is a flow diagram illustrating the machine learning model training method 210 according to some embodiments of this disclosure. The machine learning model training method 210 includes steps S212-S218. The machine learning model training method 210 can be performed by the machine learning model training system 100. The processor 120 is configured to perform steps S212-S218.

Step S212 is executed by the processor 120, to train a first model M1 according to the first set of labels L1 and the first training set D1. More particularly, the processor 120 utilizes the first set of labels L1 and the first training set D1 as a training dataset to fit the parameters of the first model M1 at step S212. In some embodiments, the first model M1 is based on image classification algorithms such as VGG-16 and/or InceptionV3. It is noticed that, step S212 can also be executed by training a pre-trained machine learning model and fitting the parameters of the pre-trained machine learning model.

In some embodiments, step S212 includes adding the first set of labels L1 and the first training set D1 as a training dataset to train a machine learning model (i.e., the first model M1) base on an image recognition machine learning model. Given the first training set D1 includes product images, and the first set of labels L1 indicates that if products in the product images of the first training set D1 are defected. The training mentioned above is to input the first set of labels L1 and the first training set D1 into a machine learning model separately, and to classify the first training set D1 according to the products in the product images are defected or not by the machine learning model. After the machine learning model generates classification results, the processor 120 checks the classification results with the first set of labels L1 in order to provide a reward signal or a punish signal correspondingly. For example, the processor 120 provides the reward signal in response to one of the classification results matches the corresponding product quality label, and provides the punish signal in response to one of the classification result does not match the corresponding product quality label.

After step S212, the processor 120 performs step S214, to labels a third training set D3, which is a portion of the training data D not included in the first training set D1, according to the first model M1, so as to generate a third set of labels L3. The processor 120 labels the portion which is not included in the first training set D1 of the training data D, namely, shown in FIG. 2A, the portion which is filled with dots and stripes of the training data D, according to the first model M1, so as to generate a third set of labels L3.

After step S214, the processor 120 performs step S216, to pre-train a second model M2 according to the third set of labels L3 and the third training set D3. More particularly, processor 120 uses the third set of labels L3 and the third training set D3 as a pre-training dataset to pre-train the second model M2 at step S216. In some embodiments, the second model M2 is based on image classification algorithms such as VGG-16 and/or InceptionV3, wherein the second model M2 and the first model M1 are based on the same algorithms. On the other hand, the second model M2 is pre-trained by training data and labels generated by the first model M1, and it is not necessarily to the second model M2 that based on the same algorithms as the first model M1. It is noticed that, step S216 can also be executed by training a pre-trained machine learning model and fitting the parameters of the pre-trained machine learning model. In an embodiment, method of pre-training the second model M2 and method of training the first model M1 are roughly the same.

After step S216, the processor 120 performs step S218, to fine-tune the second model M2 according to the second set of labels L2 and the second training set D2, so as to generate a third model M3. More particularly, the processor 120 fits the parameter of the second model M2 pre-trained at step S216 according to the second set of labels L2 and the second training set D2 at step S218, so as to generate a third model M3.

In an embodiment, after the pre-training of the second model M2, parameters of the convolution layers and parameters of the fully connected layer are generated. During the fine-tuning of the third model M3 based on the second model M2, only a portion of the parameters of the convolution layers are fitted (e.g., only parameters in the convolution layer CONV3 are fitted, but parameters in the convolution layer CONV1 and CONV2 are not fitted). Namely, after the second model M2 is fine-tuned, some of the parameters of the second model M2 have not been fitted and/or changed, and are preserved to the third model M3.

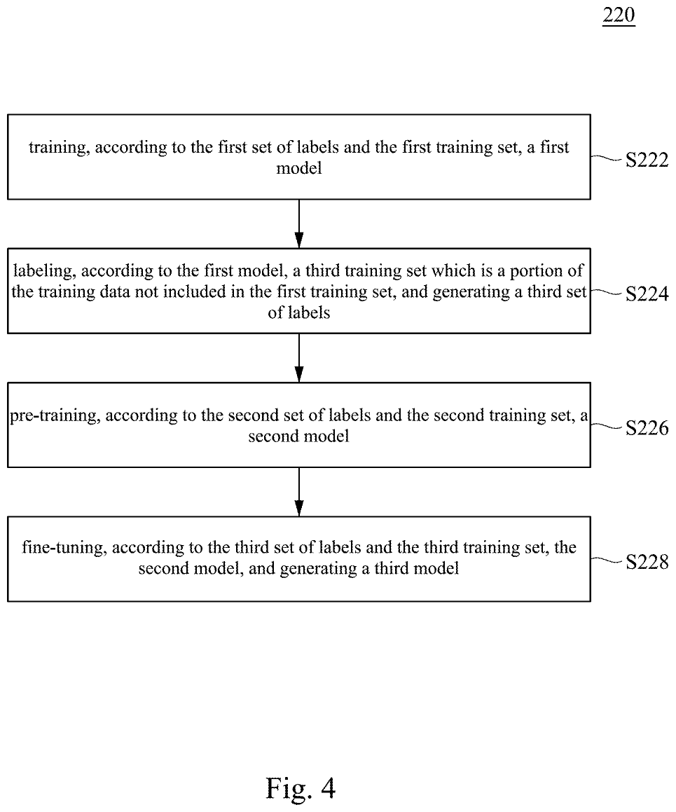

Reference is further made to FIG. 4, which is a flow diagram illustrating the machine learning model training method 220 according to some embodiments of this disclosure. The machine learning model training method 220 includes steps S222-S228. The machine learning model training method 220 can be performed by the machine learning model training system 100. The processor 120 is configured to perform steps S222-S228.

The machine learning model training method 220 is similar to the machine learning model training method 210, step S222 in the machine learning model training method 220 corresponds to step S212 in the machine learning model training method 210; step S224 in the machine learning model training method 220 corresponds to step S214 in the machine learning model training method 210; step S226 in the machine learning model training method 220 corresponds to step S216 in the machine learning model training method 210; and step S228 in the machine learning model training method 220 corresponds to step S218 in the machine learning model training method 210. Wherein step S222 in the machine learning model training method 220 is the same as step S212 in the machine learning model training method 210, and step S224 in the machine learning model training method 220 is the same as step S214 in the machine learning model training method 210.

For clarity, the discussion will focus on differences between the machine learning model training method 220 and the machine learning model training method 210. Relative to step S216, which pre-trains the second model M2 according to the third set of labels L3 and the third training set D3, of the machine learning model training method 210, step S226 of the machine learning model training method 220 pre-trains the second model M2 according to the second set of labels L2 and the second training set D2. On the other hand, relative to step S218, which fine-tunes the second model M2 according to the second set of labels L2 and the second training set D2 and generates the third model M3, of the machine learning model training method 210, step S228 of the machine learning model training method 220 fine-tunes the second model M2 according to the third set of labels L3 and the third training set D3, and generates the third model M3.

In general, during the pre-training of a machine learning model, in order to prevent local optimization or overfitting, a certain quantity of training data is needed to perform the pre-training to ensure that the machine learning model pre-trained has a certain amount of correct rate. Thus, in some embodiments, both step S216 of the machine learning model training method 210 and step S226 of the machine learning model training method 220 pre-train the second model M2 according to the labels which have the larger quantity of labels between the second set of labels L2 and the third set of labels L3. That is, if the second set of labels L2 is less than the third set of labels L3, the machine learning model training system 100 performs the machine learning model training method 210, to pre-train the second model M2 according to the third set of labels L3 and the third training set D3. On the contrary, if the second set of labels L2 is more than the third set of labels L3, the machine learning model training system 100 performs the machine learning model training method 220, to pre-train the second model M2 according to the second set of labels L2 and the second training set D2.

Further, in the machine learning model training method 220, the second model M2 is pre-trained according to the second set of labels L2 and the second training set D2, thus, in step S228 of the machine learning model training method 220, processor 120 fine-tunes the second model M2 according to the third set of labels L3 and the third training set D3, and generates the third model M3.

In some embodiments, a non-transitory computer-readable storage medium is described. The non-transitory computer-readable storage medium stores: a training data D; a first set of labels L1, which corresponds to a first training set D1 of the training data D; a second set of labels L2, which corresponds to a second training set D2 of the training data D; and at least one instructions program which executed by a processor 120 to perform the machine learning model training method 210 as shown in FIG. 3 and/or the machine learning model training method 220 as shown in FIG. 4.

In practice, for example, the verified and/or experienced labelers are relatively lesser, and a first set of labels L1 which has a relatively higher correct rate and reliability is relatively lesser or harder to get, therefore, due to time cost considerations, first, the machine learning model training method 210 and the machine learning model training method 220 train a first model M1 according to the first set of labels L1 and a first training set D1, label the other training data (namely the third training set D3) according to the first model M1, and generate a third set of labels L3 to increase labels that can be further used to train a machine learning model. Next, the machine learning model training method 210 and the machine learning model training method 220 pre-train a second model M2 according to the labels which have the larger quantity of labels between the second set of labels L2 and the third set of labels L3. Finally, the machine learning model training method 210 and the machine learning model training method 220 fine-tune the second model M2 according to the labels which have the smaller quantity of labels between the second set of labels L2 and the third set of labels L3, and generating a third model M3. The methods can utilize the limited quantity of labels and training data to train, pre-train, and fine-tune machine learning models at different steps correspond to correct rates and reliabilities of labelers of the different sets of labels, in order to generate a machine learning model which has a relatively higher correct rate and reliability.

According to the embodiments mentioned above, the machine learning model training system 100 generates the third model M3 through performing the machine learning model training method 210 and the machine learning model training method 220. The third model M3 is configured to label images which of the same type as the training data D, for example, through calculation by the third model M3, product images can be classified into product images of defected products and product images of well-made products; and through calculation of the third model M3, medical images can be classified into medical images of abnormal physiological features and medical images without abnormal physiological feature therein.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A machine learning model training method, configured to train a machine learning model according to training data, the training data comprising a first training set labeled with a first set of labels and a second training set labeled with a second set of labels, the machine learning model training method comprising:
training, according to the first set of labels and the first training set, a first model;
labeling, according to the first model, a third training set which is a portion of the training data not included in the first training set, and generating a third set of labels;
pre-training, according to the third set of labels and the third training set, a second model; and
fine-tuning, according to the second set of labels and the second training set, the second model, and generating a third model.

2. The machine learning model training method of claim 1, wherein:
the first set of labels is generated by a first labeler;
the second set of labels is generated by a second labeler; and
the first labeler is a labeler which has a higher correct rate than the second labeler.

3. The machine learning model training method of claim 1, wherein:
the second training set is a portion which is labeled with same labels generated by second labelers of the training data; and
another portion, which is labeled with different labels generated by the second labelers, of the training data is not included in the second training set.

4. The machine learning model training method of claim 1, wherein the second set of labels is less than the third set of labels.

5. The machine learning model training method of claim 1, wherein the step of training the first model and pre-training the second model are utilized by different machine learning algorithms.

6. A machine learning model training method, configured to train a machine learning model according to training data, the training data comprising a first training set labeled with a first set of labels and a second training set labeled with a second set of labels, the machine learning model training method comprising:
training, according to the first set of labels and the first training set, a first model;
labeling, according to the first model, a third training set which is a portion of the training data not included in the first training set, and generating a third set of labels;
pre-training, according to the second set of labels and the second training set, a second model; and
fine-tuning, according to the third set of labels and the third training set, the second model, and generating a third model.

7. The machine learning model training method of claim 6, wherein:
the first set of labels is generated by a first labeler;
the second set of labels is generated by a second labeler; and
the first labeler is a labeler which has a higher correct rate than the second labeler.

8. The machine learning model training method of claim 6, wherein:
the second training set is a portion which is labeled with same labels generated by second labelers of the training data; and
another portion, which is labeled with different labels generated by the second labelers, of the training data is not included in the second training set.

9. The machine learning model training method of claim 6, wherein the second set of labels is more than the third set of labels.

10. The machine learning model training method of claim 6, wherein the step of training the first model and pre-training the second model are utilized by different machine learning algorithms.

11. A machine learning model training system, comprising:
a storing device is configured to store:
training data, configured to train a machine learning model;
a first set of labels, which corresponds to a first training set of the training data; and
a second set of labels, which corresponds to a second training set of the training data; and
a processor, electrically connected to the storing device, wherein the processor is configured to:
training, according to the first set of labels and the first training set, a first model;
labeling, according to the first model, a third training set which is a portion of the training data not included in the first training set, and generating a third set of labels;
pre-training, according to the third set of labels and the third training set, or according to the second set of labels and the second training set, a second model; and
fine-tuning, according to the second set of labels and the second training set, or according to the third set of labels and the third training set, the second model, and generating a third model.

12. The machine learning model training system of claim 11, wherein the processor is further configured to:
in response to the second set of labels is less than the third set of labels, pre-training the second model according to the third set of labels and the third training set; and
fine-tuning, according to the second set of labels and the second training set, the second model, and generating a third model.

13. The machine learning model training system of claim 11, wherein the processor is further configured to:
in response to the second set of labels is more than the third set of labels, pre-training the second model according to the second set of labels and the second training set; and
fine-tuning, according to the third set of labels and the third training set, the second model, and generating a third model.
